(19) United States
(12) Patent Application Publication
(10) Pub. No.: US 2017/0175670 A1
(43) Pub. Date: Jun. 22, 2017

(54) INTERNAL COMBUSTION ENGINE, VEHICLE HAVING THE SAME, AND METHOD FOR MANUFACTURING INTERNAL COMBUSTION ENGINE

(71) Applicant: YAMAHA HATSUDOKI KABUSHIKI KAISHA, Iwata-shi (JP)

(72) Inventor: Wataru NISHIMURA, Shizuoka (JP)

(21) Appl. No.: 15/379,525

(22) Filed: Dec. 15, 2016

(30) Foreign Application Priority Data
Dec. 17, 2015 (JP) 2015-246685

(51) Int. Cl. F02F 1/42; F02B 31/02; B23B 41/12; F02M 35/10

(52) U.S. Cl. CPC F02F 1/4235; F02M 35/10091; F02M 35/10209; F02B 31/02; F02M 35/10367; B23B 41/12; F02F 2200/00; B23B 2215/24

(57) ABSTRACT

In an internal combustion engine, an angle defined by an axis of a boundary of an intake port adjoining a valve seat and a cylinder axis is greater than an angle defined by the axis of the valve seat and the cylinder axis. A step between a first inner wall and a second inner wall, the first inner wall being a portion of an inner wall of the valve seat that is closest to the cylinder axis and the second inner wall being a portion of an inner wall of the boundary of the intake port that is closest to the cylinder axis. The first inner wall is located on the outer side in the radial direction of the intake port than the second inner wall.

This application claims the benefit of priority to Japanese Patent Application No. 2015-246685 filed on Dec. 17, 2015. The entire contents of this application are hereby incorporated herein by reference.

### BACKGROUND OF THE INVENTION

1. Field of the Invention

The present invention relates to an internal combustion engine including an intake port provided with a valve seat, a vehicle including the same, and a method for manufacturing an internal combustion engine.

2. Description of the Related Art

As shown in FIG. 10, a valve seat 102 that receives an intake valve (not shown) is provided at the downstream end of an intake port 101 of an internal combustion engine. Since the intake port 101 is curved, the axis of the intake port 101 varies depending on the position along the intake port 101. When the axis L101 of a boundary 101a of the intake port 101 adjoining the valve seat 102 and the axis L102 of the valve seat 102 coincide with each other, the outline of the boundary 101a of the intake port 101 and the outline of the valve seat 102, as seen from the direction of the axis L101, both have a perfect circular shape. Therefore, with the inner diameter being equal, there will be no gap between the intake port 101 and the valve seat 102. When the axis L101 and the axis L102 coincide with each other, after a throat cutter 104 is inserted into the intake port 101 to machine the downstream end of the intake port 101, the valve seat 102 is able to be inserted therein.

As an intake port that improves the combustion efficiency, a “slant intake port” is known in the art, which is an intake port of which the axis L101 of the boundary 101a of the intake port 101 is inclined from the axis L102 of the valve seat 102 as shown in FIG. 11. For example, Japanese Laid-Open Patent Publication No. 2007-46457 discloses an internal combustion engine including such a slant intake port. With a slant intake port, it is possible to generate a strong tumble flow inside the combustion chamber, thus improving the combustion efficiency by virtue of the tumble flow.

When the axis L101 of the boundary 101a of the intake port 101 is inclined from the axis L102 of the valve seat 102, the outline of the boundary 101a of the intake port 101 has a perfect circular shape but the outline of the valve seat 102 has an elliptical shape, as seen from the direction of the axis L101. Therefore, in the prior art, in order to prevent the formation of a step between the intake port 101 and the valve seat 102, after the valve seat 102 is inserted into a cylinder head 103, the throat cutter 104 is inserted into the valve seat 102 and the intake port 101 to simultaneously machine the valve seat 102 and the intake port 101. This achieves a slant intake port where the intake port 101 and the valve seat 102 are smoothly continuous with each other without a step therebetween.

However, the valve seat 102 is made of a material that is harder than the intake port 101. With the conventional technique described above, the throat cutter 104 wears out easily because it is used for machining not only the intake port 101 but also the valve seat 102. Thus, with a conventional internal combustion engine including a slant intake port, since the throat cutter 104 wears out easily, the throat cutter 104 needs to be replaced frequently. This results in a high machining cost.

### SUMMARY OF THE INVENTION

Preferred embodiments of the present invention provide an inexpensive internal combustion engine with improved combustion efficiency due to a tumble flow.

As a result of an in-depth study, the present inventor discovered that, even if there is a step between the valve seat and the boundary of the intake port, it is possible to maintain a tumble flow if the step is shaped so that the inner wall of the valve seat is located on the outer side in the radial direction of the intake port with respect to the inner wall of the boundary of the intake port. Therefore, the present inventor discovered a configuration in which such a step is provided intentionally and the valve seat is not machined by the throat cutter.

An internal combustion engine according to a preferred embodiment of the present invention includes a cylinder body defining a cylinder therein; a cylinder head fixed on the cylinder body; an intake port in the cylinder head, a downstream end of the intake port including an opening that faces the cylinder; and a valve seat inserted into the downstream end of the intake port. Along a cross section including an axis of the cylinder and an axis of the valve seat, an angle defined by an axis of a boundary of the intake port adjoining the valve seat and the axis of the cylinder is greater than an angle defined by the axis of the valve seat and the axis of the cylinder. A step is provided along the cross section between a first inner wall and a second inner wall, the first inner wall being a portion of an inner wall of the valve seat that is closest to the axis of the cylinder and the second inner wall being a portion of an inner wall of the boundary of the intake port that is closest to the axis of the cylinder, wherein the first inner wall is located on an outer side in a radial direction of the intake port with respect to the second inner wall.

With this internal combustion engine, after the intake port is machined with the throat cutter, the valve seat is inserted therein. Therefore, it is not necessary to machine both of the intake port and the valve seat with the throat cutter, and it is possible to save the wear of the throat cutter. Thus, it is possible to provide a slant intake port, while saving the machining cost. Therefore, according to preferred embodiments of the present invention, it is possible to provide an inexpensive internal combustion engine whose combustion efficiency is improved by virtue of a tumble flow.

According to a preferred embodiment of the present invention, a step is defined by a first half of the inner wall and a second half of the inner wall, the first half being a half of the inner wall of the valve seat that is closest to the axis of the cylinder and the second half being a half of the inner wall of the boundary of the intake port that is closest to the axis of the cylinder. The first half is located on the outer side in the radial direction of the intake port with respect to the second half.

According to the preferred embodiment described above, it is possible to further save the machining cost.

According to another preferred embodiment of the present invention, a step is defined by an entire length of the inner wall of the valve seat and an entire length of the inner wall of the boundary of the intake port. The inner wall of the valve seat is located on the outer side in the radial direction of the intake port with respect to the inner wall of the boundary of the intake port.

According to the preferred embodiment described above, it is possible to further save the machining cost.

According to another preferred embodiment of the present invention, a step is provided along the cross section between a third inner wall and a fourth inner wall, the third inner wall being a portion of the inner wall of the valve seat that is farther away from the axis of the cylinder and the fourth inner wall being a portion of the inner wall of the boundary of the intake port that is farther away from the axis of the cylinder. The third inner wall is located on the outer side in the radial direction of the intake port with respect to the fourth inner wall. The step between the first inner wall and the second inner wall preferably is larger than the step between the third inner wall and the fourth inner wall.

The intake port is shaped so that it extends closer to the axis of the cylinder in the downstream direction. Therefore, the step between first inner wall and the second inner wall has a greater influence on the tumble flow than the step between the third inner wall and the fourth inner wall. As a result of an in-depth study, the present inventor discovered that a tumble flow is able to be maintained with a step that extends toward the outer side in the radial direction of the intake port in the downward direction, whereas a tumble flow is not sufficiently maintained with a step that extends toward the inner side in the radial direction of the intake port in the downward direction. When the design is such that the step between the first inner wall and the second inner wall is larger than the step between the third inner wall and the fourth inner wall, as in a preferred embodiment of the present invention, even if the position of the throat cutter is slightly shifted away from the axis of the cylinder during the machining process, a step that extends toward the outer side in the radial direction of the intake port in the downward direction is reliably provided between the first inner wall and the second inner wall. Therefore, it is possible to increase the tolerance for machining errors, thus further saving the machining cost.

According to another preferred embodiment of the present invention, the boundary of the intake port preferably has an elliptical or substantially elliptical shape as seen from a direction of the axis of the valve seat.

According to the preferred embodiment described above, after the intake port is machined with the throat cutter to machine a hole having a perfect circular shape, the valve seat is inserted therein.

A vehicle according to a preferred embodiment of the present invention includes the internal combustion engine as set forth above.

A method for manufacturing an internal combustion engine according to a preferred embodiment of the present invention includes the steps of: inserting a throat cutter into a cylinder head provided with an intake port along a first axis from a downstream end of the intake port and machining an inner wall of the intake port with the throat cutter; and inserting a valve seat into the downstream end of the intake port along a second axis, which defines an angle with respect to an axis of the cylinder along a cross section including the axis of the cylinder and the first axis that is smaller than an angle of the first axis with respect to the axis of the cylinder along the cross section. In the step of inserting the valve seat, a step is provided at least along the cross section between a first inner wall and a second inner wall, the first inner wall being a portion of an inner wall of the valve seat that is closest to the axis of the cylinder and the second inner wall being a portion of an inner wall of a boundary of the intake port adjoining the valve seat that is closest to the axis of the cylinder, wherein the first inner wall is located on an outer side in a radial direction of the intake port with respect to the second inner wall.

According to a preferred embodiment of the present invention, in the step of inserting the valve seat, a step is defined by a first half of the inner wall and a second half of the inner wall, the first half being a half of the inner wall of the valve seat that is closest to the axis of the cylinder and the second half being a half of the inner wall of the boundary of the intake port that is closest to the axis of the cylinder, wherein the first half is located on the outer side in the radial direction of the intake port with respect to the second half.

According to another preferred embodiment of the present invention, in the step of inserting the valve seat, a step is defined by an entire length of the inner wall of the valve seat and an entire length of the inner wall of the boundary of the intake port, wherein the inner wall of the valve seat is located on the outer side in the radial direction of the intake port with respect to the inner wall of the boundary of the intake port.

According to another preferred embodiment of the present invention, in the step of inserting the valve seat, a step is provided along the cross section between a third inner wall and a fourth inner wall, the third inner wall being a portion of the inner wall of the valve seat that is farther away from the axis of the cylinder and the fourth inner wall being a portion of the inner wall of the boundary of the intake port that is farther away from the axis of the cylinder, wherein the third inner wall is located on the outer side in the radial direction of the intake port with respect to the fourth inner wall. The step between the first inner wall and the second inner wall is larger than the step between the third inner wall and the fourth inner wall.

According to another preferred embodiment of the present invention, the step of machining the inner wall of the intake port with the throat cutter is performed using a throat cutter having a diameter that is smaller than a valve head diameter of an intake valve provided in the intake port by about 4.5 mm or more, for example.

As described above, according to preferred embodiments of the present invention, it is possible to provide an inexpensive internal combustion engine whose combustion efficiency is improved by virtue of a tumble flow.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a side view of a motorcycle according to a preferred embodiment of the present invention.

FIG. 2 is a cross-sectional view of an internal combustion engine installed on the motorcycle.

FIG. 3 is a cross-sectional view of a cylinder head of the internal combustion engine.

FIG. 4 is an enlarged cross-sectional view of a portion of the cylinder head.

FIG. 5 is an enlarged view of a portion of FIG. 4.

FIG. 6 is an enlarged view of another portion of FIG. 4.

FIG. 7 is a view, corresponding to FIG. 6, for an internal combustion engine according to another preferred embodiment of the present invention.

FIG. 8 is a view schematically showing an outline of a boundary of an intake port and an outline of a boundary of a valve seat, as seen from the direction of the axis of the valve seat.

FIG. 9 is a diagram showing a tumble flow inside a combustion chamber of the internal combustion engine.

FIG. 10 is a partial cross-sectional view of a cylinder head in a conventional internal combustion engine where the axis of the intake port and the axis of the valve seat coincide with each other.

FIG. 11 is a partial cross-sectional view of a cylinder head in a conventional internal combustion engine including a slant intake port.

### DETAILED DESCRIPTION OF THE PREFERRED EMBODIMENTS

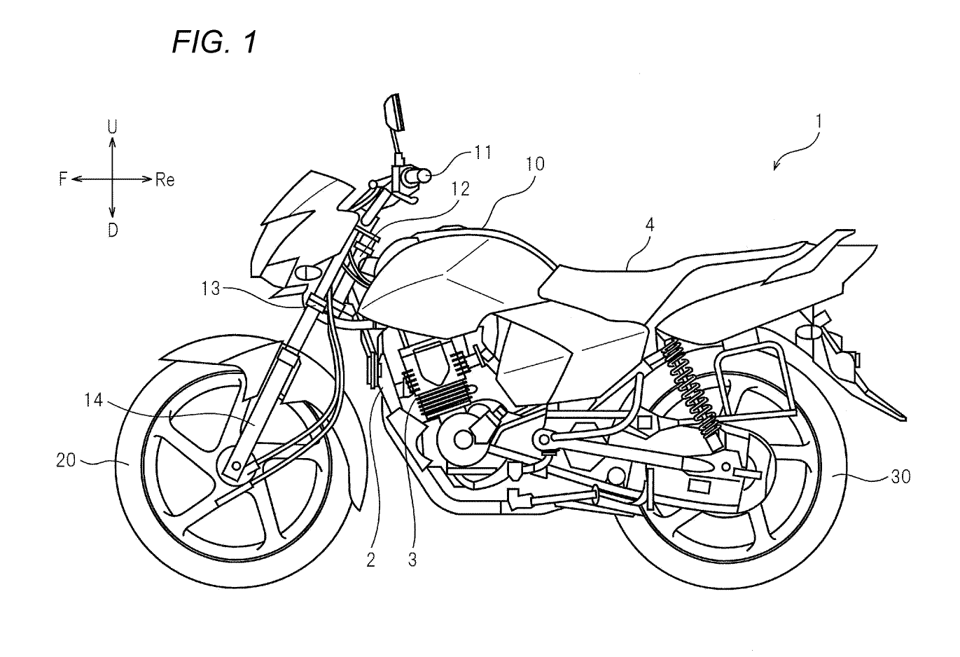

Preferred embodiments of the present invention will now be described with reference to the drawings. As shown in FIG. 1, a vehicle of the present preferred embodiment is a motorcycle 1, which is a non-limiting example of a straddled vehicle to be straddled by a passenger. Note, however, that the vehicle is not limited to the motorcycle 1, but may be any other straddled vehicle, such as a three-wheeled vehicle, an all terrain vehicle (ATV) and a snowmobile, to be straddled by a passenger. Vehicles according to various preferred embodiments of the present invention may be vehicles other than a straddled vehicle.

As shown in FIG. 1, the motorcycle 1 includes a vehicle body frame 2 including a head pipe 12, a power unit 3 supported on the vehicle body frame 2, a front wheel 20 and a rear wheel 30. A steering shaft 13 is rotatably supported on the head pipe 12. A handle bar 11 is fixed on an upper portion of the steering shaft 13, and a front fork 14 is fixed on a lower portion of the steering shaft 13. The front wheel 20 is attached to the front fork 14. A fuel tank 10 is located above the power unit 3. The seat 4 is located rearward of the fuel tank 10. The power unit 3 is linked to the rear wheel 30 via a transmission such as a chain (not shown).

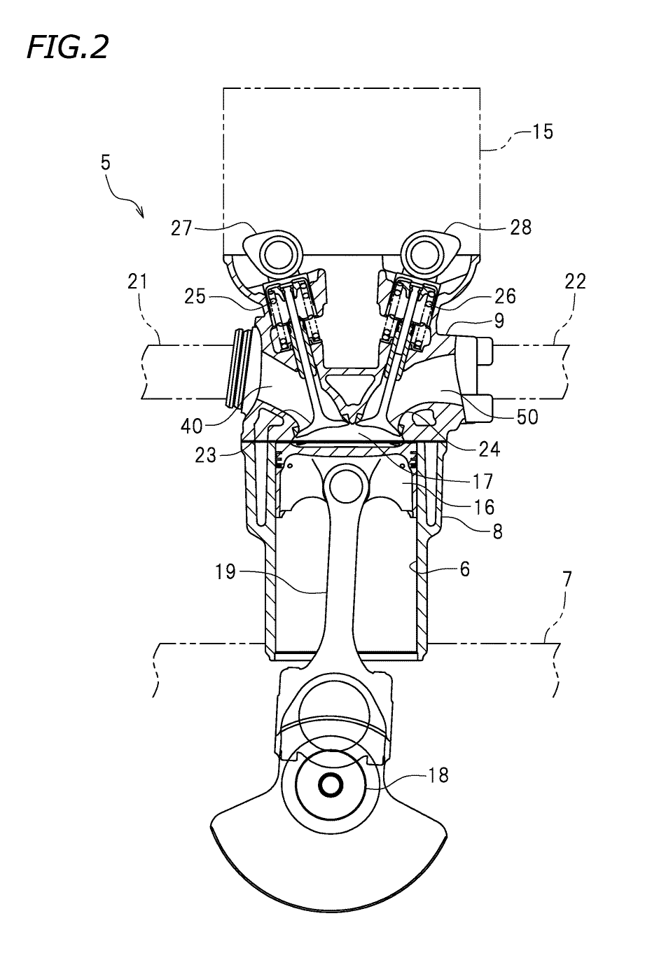

As shown in FIG. 2, the power unit 3 includes an internal combustion engine 5. The power unit 3 drives the rear wheel 30 using the power from the internal combustion engine 5. In the present preferred embodiment, the internal combustion engine 5 is, for example, a single-cylinder internal combustion engine including a single cylinder 6. Note, however, that the internal combustion engine 5 may be a multi-cylinder internal combustion engine including a plurality of cylinders.

The internal combustion engine 5 includes a crankcase 7, a cylinder block 8 fixed on the crankcase 7, a cylinder head 9 fixed on the cylinder block 8, and a cylinder head cover 15 fixed on the cylinder head 9. The cylinder 6 is located inside the cylinder block 8, and a piston 16 is located inside the cylinder 6. Note that the cylinder 6 may be separate from, or integral with, the cylinder block 8. A combustion chamber 17 is defined by the piston 16, the cylinder 6 and the cylinder head 9. A crankshaft 18 is located inside the crankcase 7. The crankshaft 18 and the piston 16 are linked together by a connecting rod 19.

The cylinder head 9 is provided with an intake port 40 and an exhaust port 50. Although not shown in the figures, the cylinder head 9 is also provided with an ignition unit facing the combustion chamber 17. An intake pipe 21 is connected to the intake port 40. An exhaust pipe 22 is connected to the exhaust port 50. An intake valve 23 is provided in the intake port 40. An exhaust valve 24 is provided in the exhaust port 50. The intake valve 23 is biased in the valve-closing direction (the upward direction in FIG. 2) by a valve spring 25. The exhaust valve 24 is biased in the valve-closing direction (the upward direction in FIG. 2) by a valve spring 26. An intake cam 27 and an exhaust cam 28 are provided inside the cylinder head 9 and the cylinder head cover 15. The intake cam 27 is in contact with the intake valve 23, and as the intake cam 27 rotates, it provides the intake valve 23 with a force in the valve-opening direction (the downward direction in FIG. 2). The exhaust cam 28 is in contact with the exhaust valve 24, and as the exhaust cam 28 rotates, it provides the exhaust valve 24 with a force in the valve-opening direction (the downward direction in FIG. 2).

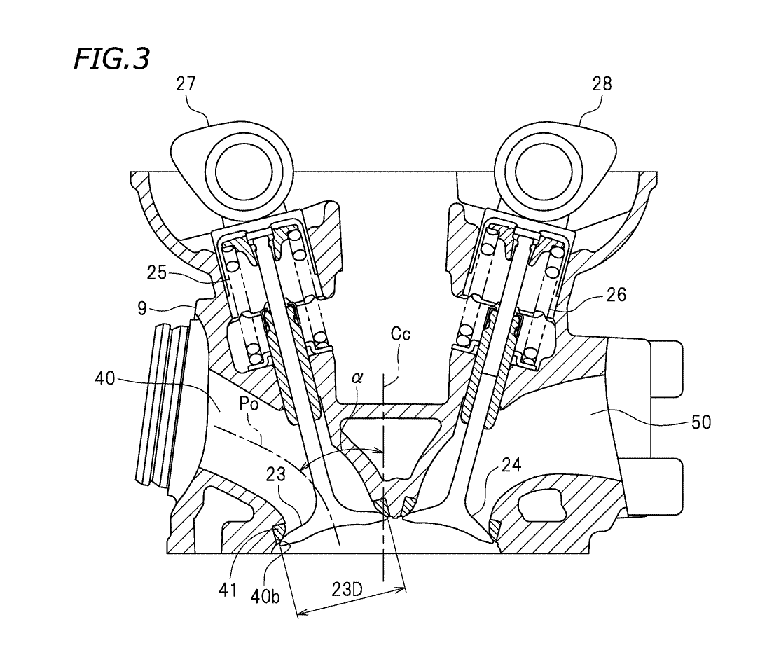

FIG. 3 is a cross-sectional view of the cylinder head 9. As shown in FIG. 3, the intake port 40 is curved so that the angle α between the axis Po of the intake port 40 (hereinafter referred to as the port axis) and the axis Cc of the cylinder 6 (hereinafter referred to as the cylinder axis) decreases in the downstream direction along the intake port 40. Note that the angle between the port axis and the cylinder axis, as used herein, refers to an angle defined by the port axis and the cylinder axis that is less than 180 degrees, unless otherwise specified.

The downstream end of the intake port 40 includes an opening that faces the cylinder 6. A seat stop 40b is provided at the downstream end of the intake port 40. A valve seat 41 is fitted into the seat stop 40b. The valve seat 41 is made from a material that is harder than the intake port 40 (i.e., a portion of the cylinder head 9). For example, the valve seat 41 is made from a sintered material, and the intake port 40 is made from an aluminum material (AC4B).

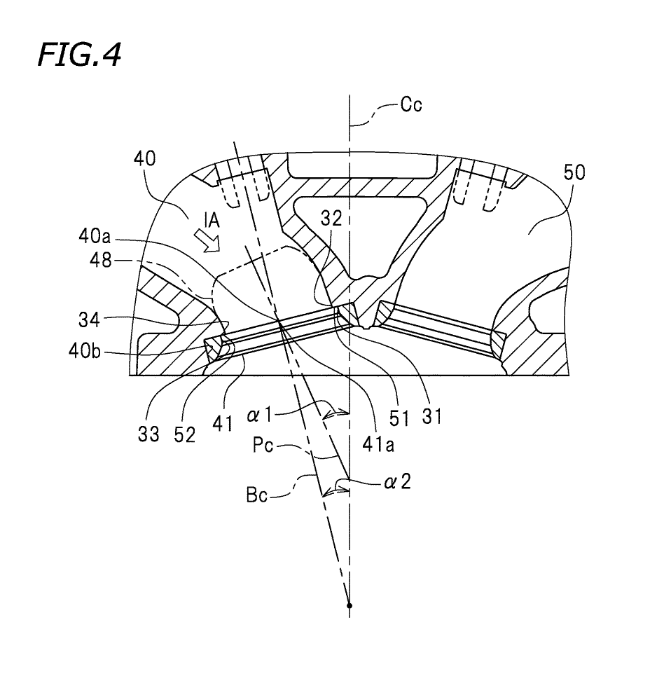

FIG. 4 is an enlarged cross-sectional view showing a portion of FIG. 3 on an enlarged scale. As shown in FIG. 4, the valve seat 41 is inserted into the seat stop 40b of the intake port 40. Since the valve seat 41 is inserted into a portion of the intake port 40, the intake port 40 includes a boundary 40a adjoining the valve seat 41. The boundary 40a is a portion of the inner wall of the intake port 40 that adjoins the inner wall of the valve seat 41. The boundary 40a is the most downstream portion of the inner wall of the intake port 40 that can be seen from the inside of the intake port 40.

The valve seat 41 includes a boundary 41a adjoining the intake port 40. The boundary 41a is a portion of the inner wall of the valve seat 41 that adjoins the inner wall of the intake port 40. The boundary 41a of the valve seat 41 adjoins the boundary 40a of the intake port 40. The boundary 41a of the valve seat 41 is the most upstream portion of the valve seat 41.

As shown in FIG. 4, along the cross section that includes the cylinder axis Cc and the axis Bc of the valve seat 41, the angle α1 defined by the axis Pc of the boundary 40a of the intake port 40 and the cylinder axis Cc is greater than the angle α2 defined by the axis Bc of the valve seat 41 and the cylinder axis Cc. Along this cross section, a portion of the inner wall of the valve seat 41 that is closest to the cylinder axis Cc is referred to as a first inner wall 31, and a portion of the inner wall of the boundary 40a of the intake port 40 that is closest to the cylinder axis Cc is referred to as a second inner wall 32. Along this cross section, a portion of the inner wall of the valve seat 41 that is farther away from the cylinder axis Cc is referred to as a third inner wall 33, and a portion of the inner wall of the boundary 40a of the intake port 40 that is farther away from the cylinder axis Cc is referred to as a fourth inner wall 34.

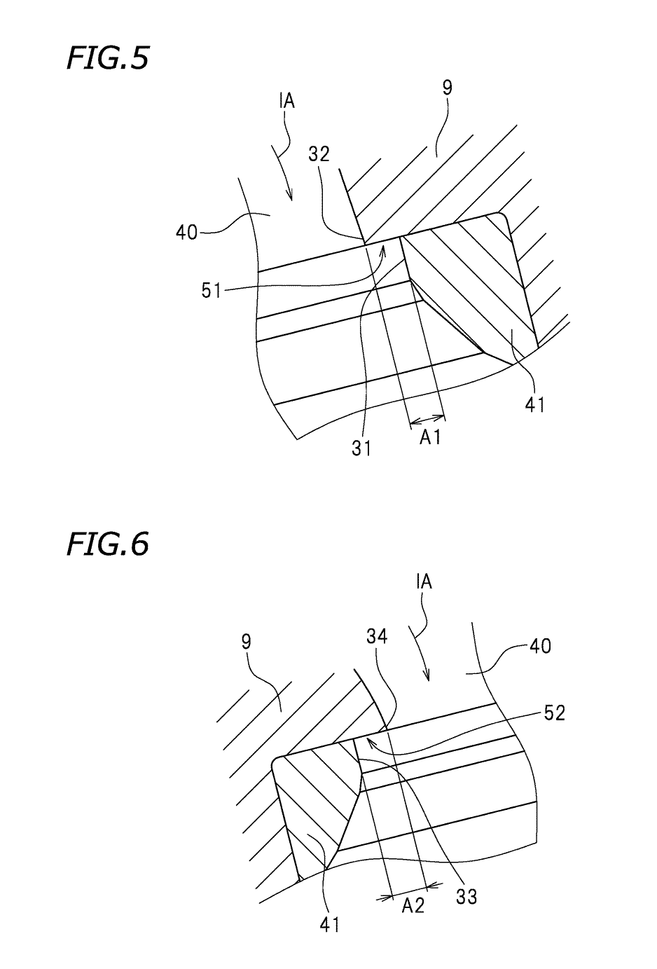

As shown in FIG. 5, a step 51 is defined by the first inner wall 31 and the second inner wall 32. The first inner wall 31 is located on the outer side in the radial direction of the intake port 40 with respect to the second inner wall 32. In other words, the distance between the axis Bc of the valve seat 41 (see FIG. 4) and the first inner wall 31 is greater than the distance between the axis Pc of the boundary 40a of the intake port 40 and the second inner wall 32. As shown in FIG. 6, a step 52 is defined by the third inner wall 33 and the fourth inner wall 34. The third inner wall 33 is located on the outer side in the radial direction of the intake port 40 with respect to the fourth inner wall 34. In other words, the distance between the axis Bc of the valve seat 41 (see FIG. 4) and the third inner wall 33 is greater than the distance between the axis Pc of the boundary 40a of the intake port 40 and the fourth inner wall 34. The inner diameter of the intake port 40 varies discretely between the boundary 40a and the valve seat 41. The inner diameter of the intake port 40 increases discretely from the boundary 40a to the valve seat 41.

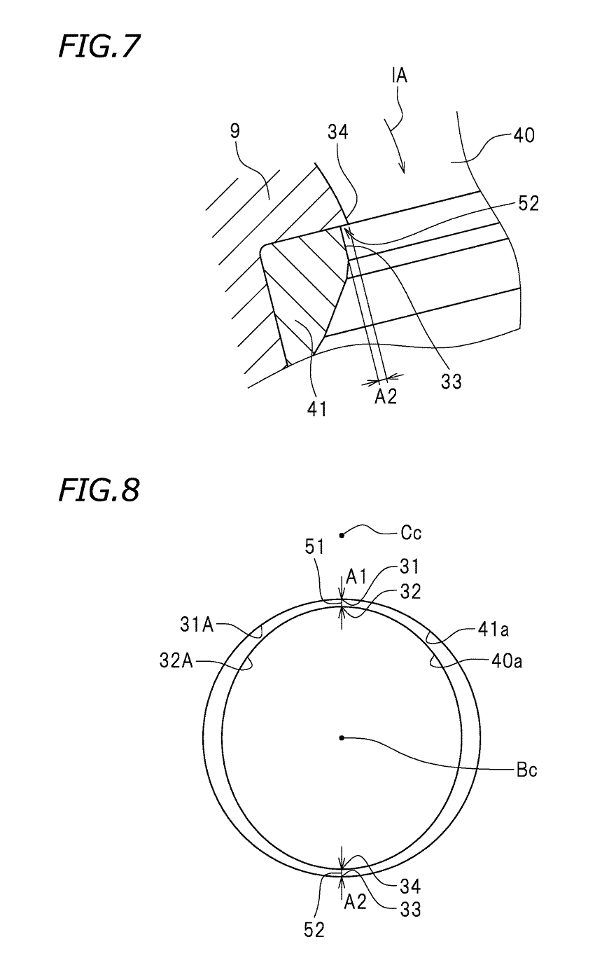

The dimension A1 of the step 51 is preferably about 1 mm or less, and may be about 0.4 to about 0.5 mm, for example. The dimension A2 of the step 52 is also preferably about 1 mm or less, for example. In the present preferred embodiment, the dimension A1 and the dimension A2 are preferably equal to each other. Note, however, that the dimension A2 may be smaller than the dimension A1 as shown in FIG. 7. The dimension A2 may be greater than the dimension A1.

FIG. 8 is a view schematically showing the outline of the boundary 40a of the intake port 40 and the outline of the boundary 41a of the valve seat 41, as seen from direction of the axis Bc of the valve seat 41. As shown in FIG. 8, the boundary 40a of the intake port 40 does not have a perfect circular shape but has an elliptical or substantially elliptical shape (the distance from the center varies), as seen from the direction of the axis Bc of the valve seat 41. Note that FIG. 8 exaggerates the elliptical or substantially elliptical shape of the boundary 40a of the intake port 40, and is not to scale.

As shown in FIG. 8, for the entire circumferential extent, the inner wall of the boundary 41a of the valve seat 41 is located on the outer side in the radial direction of the intake port 40 with respect to the inner wall of the boundary 40a of the intake port 40. A step is defined by the entire length of the inner wall of the boundary 41a of the valve seat 41 and the entire length of the inner wall of the boundary 40a of the intake port 40.

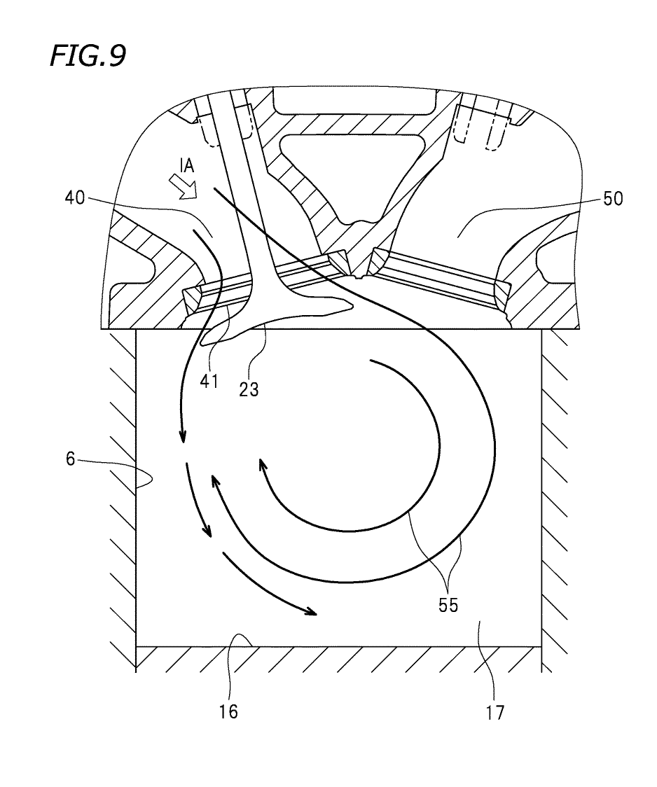

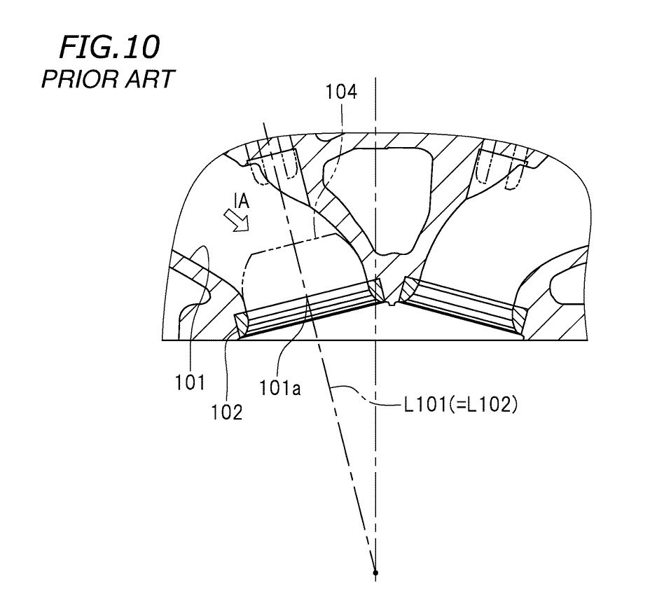

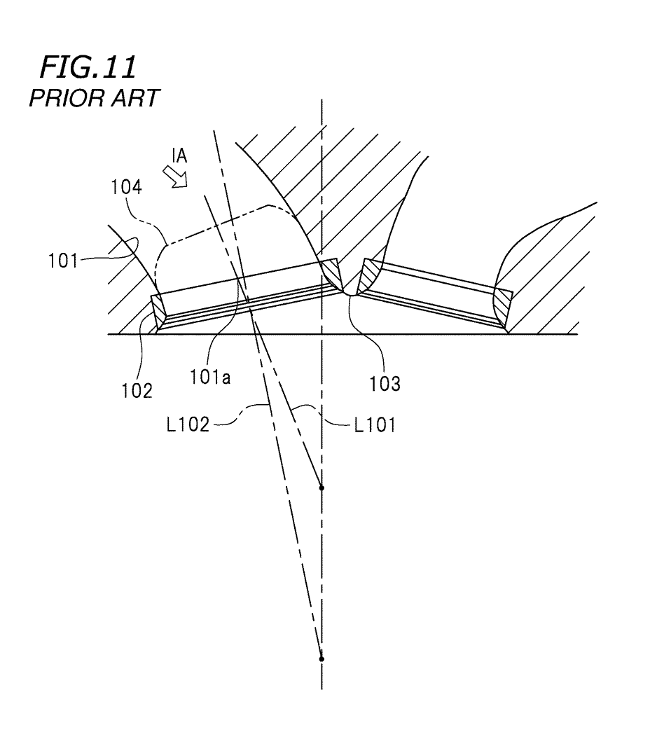

The internal combustion engine 5 preferably has the configuration described above. With the internal combustion engine 5 of the present preferred embodiment, the axis Pc of the boundary 40a of the intake port 40 is inclined from the axis Bc of the valve seat 41, and the intake port 40 is a “slant intake port”. As shown in FIG. 9, an air-fuel mixture IA is sucked into the combustion chamber 17 via the intake port 40, and the mixture IA generates a tumble flow 55 in the combustion chamber 17. With the internal combustion engine 5 of the present preferred embodiment, this tumble flow 55 improves the combustion efficiency.

Next, the method of machining the intake port 40 and installing the valve seat 41 will be described. Note that this method is a portion of the process for manufacturing the internal combustion engine 5.

First, the cylinder head 9 provided with the intake port 40 and the seat stop 40b is secured to a jig, and a throat cutter 48 is inserted into the intake port 40 along the first axis from the downstream end thereof (see FIG. 4). Then, the inner wall of the intake port 40 is machined with the throat cutter 48. Note that the first axis is the axis Pc of the boundary 40a of the intake port 40. Although there is no particular limitation on the dimension of the throat cutter 48, the throat cutter 48 preferably has a diameter that is smaller than the valve head diameter 23D of the intake valve 23 by, for example, about 4.5 mm or more (see FIG. 3). With the throat cutter 48 having such a dimension, it is possible to desirably machine the intake port 40 and desirably form the steps as described above including the steps 51 and 52.

Next, the throat cutter 48 is pulled out of the intake port 40. Then, the valve seat 41 is inserted into the seat stop 40b along the second axis, which defines the angle α2 with respect to the cylinder axis Cc along a cross section including the cylinder axis Cc and the first axis (the cross section of FIG. 4) that is smaller than the angle α1 of the first axis with respect to the cylinder axis Cc along the cross section. Note that the second axis is the axis Bc of the valve seat 41.

After the valve seat 41 is inserted as described above, the step 51 is defined by the first inner wall 31 and the second inner wall 32 and the step 52 is defined by the third inner wall 33 and the fourth inner wall 34 along the cross section. A step is defined by a first half 31A of the valve seat 41 and a second half 32A of the boundary 40a of the intake port 40 such that the first half 31A is located on the outer side in the radial direction of the intake port 40 with respect to the second half 32A. A step is defined by the entire length of the inner wall of the valve seat 41 and the entire length of the inner wall of the boundary 40a of the intake port 40 such that the inner wall of the valve seat 41 is located on the outer side in the radial direction of the intake port 40 with respect to the inner wall of the boundary 40a of the intake port 40.

It is possible as described above to machine the intake port 40 and then install the valve seat 41. That is, it is possible to produce the slant intake port 40 provided with the valve seat 41. With the method described above, the valve seat 41, which is made of a material that is harder than the intake port 40, is not machined with the throat cutter 48. Therefore, it is possible to save the wear of the throat cutter 48 as compared with the conventional method in which the intake port 40 and the valve seat 41 are both machined with the throat cutter 48. Thus, when manufacturing a plurality of internal combustion engines 5, it is no longer necessary to frequently replace the throat cutter 48, saving the machining cost.

As described above, it is possible to produce the slant intake port 40 provided with the valve seat 41 by machining the intake port 40 with the throat cutter 48 and then insert the valve seat 41 into the intake port 40. It is not necessary to machine both of the intake port 40 and the valve seat 41 with the throat cutter 48, and it is possible to save the wear of the throat cutter 48. Thus, it is possible to provide the slant intake port 40 that creates a strong tumble flow, while saving the machining cost. Accordingly, it is possible to provide an inexpensive internal combustion engine 5 whose combustion efficiency is improved by virtue of a tumble flow.

As described above with reference to FIG. 5 and FIG. 7, the dimension A1 of the step 51 between the first inner wall 31 and the second inner wall 32 may be greater than the dimension A2 of the step 52 between the third inner wall 33 and the fourth inner wall 34. The intake port 40 extends closer to the cylinder axis Cc in the downstream direction. Therefore, the step 51 has a greater influence on the tumble flow 55 than the step 52. As a result of an in-depth study, the present inventor discovered that a tumble flow is maintained with a step that extends toward the outer side in the radial direction of the intake port 40 in the downstream direction, whereas a tumble flow is not sufficiently maintained with a step that extends toward the inner side in the radial direction of the intake port 40 in the downstream direction. When the design is such that the step 51 is larger than the step 52, as in a preferred embodiment of the present invention, even if the position of the throat cutter 48 is slightly shifted away from the cylinder axis Cc during the machining process, the step 51 that extends toward the outer side in the radial direction of the intake port 40 in the downstream direction is defined by the first inner wall 31 and the second inner wall 32. Therefore, by making a design in advance such that the step 51 will be larger than the step 52, it is possible to increase the tolerance for machining errors, thus further saving the machining cost.

Note that the preferred embodiments of the present invention described above are merely examples of the preferred embodiments of the present invention, and the present invention can be carried out by various other preferred embodiments.

The number of intake ports 40 for one cylinder 6 in the internal combustion engine 5 may be one or more. The steps described above may be provided in each of a plurality of intake ports 40.

While the internal combustion engine 5 of the preferred embodiments described above is preferably a single-cylinder internal combustion engine including a single cylinder, the internal combustion engine may be a multi-cylinder internal combustion engine including a plurality of cylinders. In such a case, steps of the preferred embodiments described above may be provided in the intake port of each cylinder.

The terms and expressions used herein are for description only and are not to be interpreted in a limited sense. These terms and expressions should be recognized as not excluding any equivalents to the elements shown and described herein and as allowing any modification encompassed in the scope of the claims. The present invention may be embodied in many various forms. This disclosure should be regarded as providing preferred embodiments of the present invention. These preferred embodiments are provided with the understanding that they are not intended to limit the present invention to the preferred embodiments described in the specification and/or shown in the drawings. The present invention is not limited to the preferred embodiments described herein. The present invention encompasses any of numerous and various preferred embodiments including equivalent elements, modifications, deletions, combinations, improvements and/or alterations which can be recognized by a person of ordinary skill in the art based on the disclosure. The elements of each claim should be interpreted broadly based on the terms used in the claim, and should not be limited to any of the preferred embodiments described in this specification or used during the prosecution of the present application.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An internal combustion engine comprising:
a cylinder body defining a cylinder therein;
a cylinder head fixed on the cylinder body;
an intake port in the cylinder head, a downstream end of the intake port including an opening that faces the cylinder; and
a valve seat in the downstream end of the intake port; wherein
along a cross section including an axis of the cylinder and an axis of the valve seat, an angle defined by an axis of a boundary of the intake port adjoining the valve seat and the axis of the cylinder is greater than an angle defined by the axis of the valve seat and the axis of the cylinder; and
a step is provided along the cross section between a first inner wall and a second inner wall, the first inner wall being a portion of an inner wall of the valve seat that is closest to the axis of the cylinder and the second inner wall being a portion of an inner wall of the boundary of the intake port that is closest to the axis of the cylinder, and the first inner wall is located on an outer side in a radial direction of the intake port with respect to the second inner wall.

2. The internal combustion engine according to claim 1, wherein a step is provided between a first half of the inner wall and a second half of the inner wall, the first half of the inner wall being a half of the inner wall of the valve seat that is closest to the axis of the cylinder and the second half of the inner wall being a half of the inner wall of the boundary of the intake port that is closest to the axis of the cylinder; and
the first half of the inner wall is located on the outer side in the radial direction of the intake port with respect to the second half of the inner wall.

3. The internal combustion engine according to claim 1, wherein a step is provided between an entire length of the inner wall of the valve seat and an entire length of the inner wall of the boundary of the intake port; and
the inner wall of the valve seat is located on the outer side in the radial direction of the intake port with respect to the inner wall of the boundary of the intake port.

4. The internal combustion engine according to claim 1, wherein a step is provided along the cross section between a third inner wall and a fourth inner wall, the third inner wall being a portion of the inner wall of the valve seat that is farther away from the axis of the cylinder than the first inner wall and the fourth inner wall being a portion of the inner wall of the boundary of the intake port that is farther away from the axis of the cylinder than the second inner wall, and the third inner wall is located on the outer side in the radial direction of the intake port with respect to the fourth inner wall; and
the step between the first inner wall and the second inner wall is larger than the step between the third inner wall and the fourth inner wall.

5. The internal combustion engine according to claim 1, wherein the boundary of the intake port has an elliptical or substantially elliptical shape as seen from a direction of the axis of the valve seat.

6. A vehicle comprising the internal combustion engine according to claim 1.

7. A method for manufacturing an internal combustion engine, the method comprising the steps of:
inserting a throat cutter into a cylinder head provided with an intake port along a first axis from a downstream end of the intake port and machining an inner wall of the intake port with the throat cutter; and
inserting a valve seat into the downstream end of the intake port along a second axis, which defines an angle with respect to an axis of the cylinder along a cross section including the axis of the cylinder and the first axis that is smaller than an angle of the first axis with respect to the axis of the cylinder along the cross section; wherein
in the step of inserting the valve seat, a step is provided at least along the cross section between a first inner wall and a second inner wall, the first inner wall being a portion of an inner wall of the valve seat that is closest to the axis of the cylinder and the second inner wall being a portion of an inner wall of a boundary of the intake port adjoining the valve seat that is closest to the axis of the cylinder, and the first inner wall is located on an outer side in a radial direction of the intake port with respect to the second inner wall.

8. The method for manufacturing an internal combustion engine according to claim 7, wherein, in the step of inserting the valve seat, a step is defined by a first half of the inner wall and a second half of the inner wall, the first half of the inner wall being a half of the inner wall of the valve seat that is closest to the axis of the cylinder and the second half of the inner wall being a half of the inner wall of the boundary of the intake port that is closest to the axis of the cylinder, and the first half is located on the outer side in the radial direction of the intake port with respect to the second half.

9. The method for manufacturing an internal combustion engine according to claim 7, wherein, in the step of inserting the valve seat, a step is defined by an entire length of the inner wall of the valve seat and an entire length of the inner wall of the boundary of the intake port, and the inner wall of the valve seat is located on the outer side in the radial direction of the intake port with respect to the inner wall of the boundary of the intake port.

10. The method for manufacturing an internal combustion engine according to claim 7, wherein
in the step of inserting the valve seat, a step is formed along the cross section between a third inner wall and a fourth inner wall, the third inner wall being a portion of the inner wall of the valve seat that is farther away from the axis of the cylinder than the first inner wall, the fourth inner wall being a portion of the inner wall of the boundary of the intake port that is farther away from the axis of the cylinder than the second inner wall, and the third inner wall is located on the outer side in the radial direction of the intake port with respect to the fourth inner wall; and
the step between the first inner wall and the second inner wall is larger than the step between the third inner wall and the fourth inner wall.

11. The method for manufacturing an internal combustion engine according to claim 7, wherein the step of machining the inner wall of the intake port with the throat cutter is performed using a throat cutter having a diameter that is smaller than a valve head diameter of an intake valve provided in the intake port by about 4.5 mm or more.
